(19) United States
(12) Patent Application Publication
(10) Pub. No.: US 2009/0267355 A1
(43) Pub. Date: Oct. 29, 2009

(54) Device for Spacing and Temporarily Locking an Opening Element on a Fixed Element

(75) Inventor: Stephane Perche, Saint Bardoux (FR)

Correspondence Address: OLIFF & BERRIDGE, PLC, P.O. BOX 320850, ALEXANDRIA, VA, 22320-4850, US

(73) Assignee: EXSTO, Romans sur Isere (FR)

(21) Appl. No.: 12/083,597

(22) PCT Filed: Oct. 17, 2006
(86) PCT No.: PCT/FR2006/002329

§ 371 Date: Jul. 24, 2008

(30) Foreign Application Priority Data
Oct. 17, 2005 (FR) 0510546

(51) Int. Cl. E05B 17/00

(52) U.S. Cl. 292/76

(57) ABSTRACT

The invention concerns a device (1) for spacing and temporarily locking into a pseudo-closed position an opening element (6) on a fixed element (3) of a motor vehicle body, comprising a fixing plate (2) for anchoring the device in the fixed element and a stop element (4) adapted to serve as support for the opening element and having one first end (11) attached to the fixed plate. The invention is characterized in that the stop element has an intermediate part (12) stretching in a direction substantially perpendicular to the fixing plate and terminated by a second end (13) curved towards the fixing plate (2), the intermediate part and the second end being configured so as to be accommodated between the fixed element and the opening element in the pseudo-closed position and to provide a space for receiving a rim (6b) thereof.

The present invention relates to a device for spacing and temporarily locking, into a pseudo-closed position, an opening element on a fixed element of a motor vehicle body.

Before permanent attachment of an opening element, such as a door, a hood or a tailgate, among others, on a fixed element of a motor vehicle body, in general steps for applying one or several coats are carried out, such as protective coatings or the application of a layer of paint. Upon such treatments, these opening elements are not yet equipped with permanent closing devices, for example locks.

For this reason, spacing and temporary locking devices are provided which make it possible to maintain an opening element in a pseudo-closed position in relation to the fixed element to which it must be attached.

Documents EP 0 931 895 and FR 2 833 562 each describe a device of this type comprising, on one hand, a fixing plate designed to enable anchoring of the device in the fixed element, and on the other hand, a body connected to the fixing plate and forming a stop element able to serve as support for the opening element.

However, one of the drawbacks of these devices is that they bear on an area of the body designed to be covered with paint. Because of this, these latching devices leave a mark on the painted body after their removal, which requires a paint touch-up.

The present invention aims to resolve the drawback described above and to this end consists of a device for spacing and temporarily locking into a pseudo-closed position an opening element on a fixed element of a motor vehicle body, comprising, on one hand, a fixing plate designed for anchoring the device in the fixed element, and on the other hand, a stop element adapted to serve as support for the opening element and having a first end attached to the fixing plate, characterized in that the stop element has an intermediate part stretching in a direction substantially perpendicular to the fixing plate and terminated by a second end curved toward the fixing plate, the intermediate part and the second end being conformed so as to be able to be housed between the fixed element and the opening element into the pseudo-closed position and to arrange a space to receive an edge of said part.

The term ‘opening element’ refers to any part of the body, such as a door, a hood or a tailgate, which is mobile in relation to the body of the motor vehicle.

Thus, providing that one part of the stop element has a curved end designed to be housed between the opening element and the fixed element enables the spacing device to bear in an area (not visible) of the opening element when said element is permanently mounted, because reserved, for example, for a lock or a covering element. Because of this, the spacing device does not prevent the application of the paint and does not leave any unpainted area on the opening element.

Advantageously, the curved end of the stop element is conformed so as to come into contact with an area of the opening element designed to receive a covering element. The covering element can, for example, be a piece of fabric or leather, or any other interior decoration element of the vehicle, or a closing hinge.

Also advantageously, the curved end is adapted so as to be able to come partially into contact with the corresponding fixed element.

Preferably, the curved end is adapted so as to be at able to be elastically deformed at least partially under the action of the stresses exerted by the opening element.

Advantageously, the device according to the invention comprises an elastic retaining pin able to cooperate with an edge of the opening element to lock the latter in the pseudo-closed position. Thus, upon movement of the fixed element along an assembly chain, the opening element is maintained in its position and does not risk opening; one edge of the opening element must be understood in the broad sense and can be made up of any type of edge.

According to a first embodiment, the fixing plate is equipped with a peg designed to cooperate with an orifice of the fixed element, and is able to receive a fixing screw designed to cooperated with a tapped orifice of the fixed element.

According to a second embodiment the fixing plate comprises fixing means able to be clipped on the fixed element of the vehicle body.

Preferably, the device according to the invention is made from a thermoplastic material able to bear a temperature equal to at least 180° C. This generally involves the temperature of the furnaces intended for drying a coating product previously applied.

Also preferably, the stop element is a single piece with the fixing plate (2).

The implementation of the invention will be better understood with the help of the detailed description below which is done in reference to the appended drawing, in which:

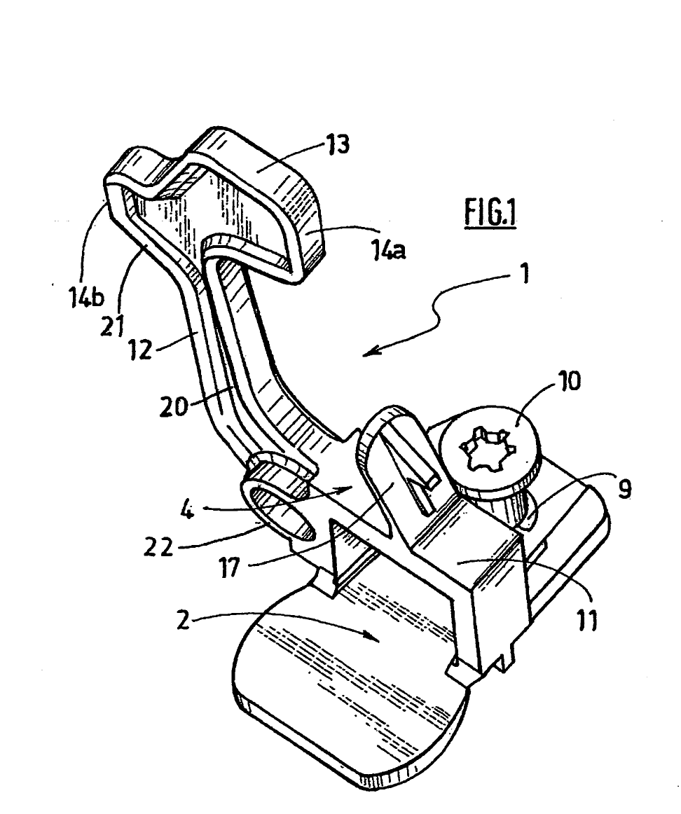

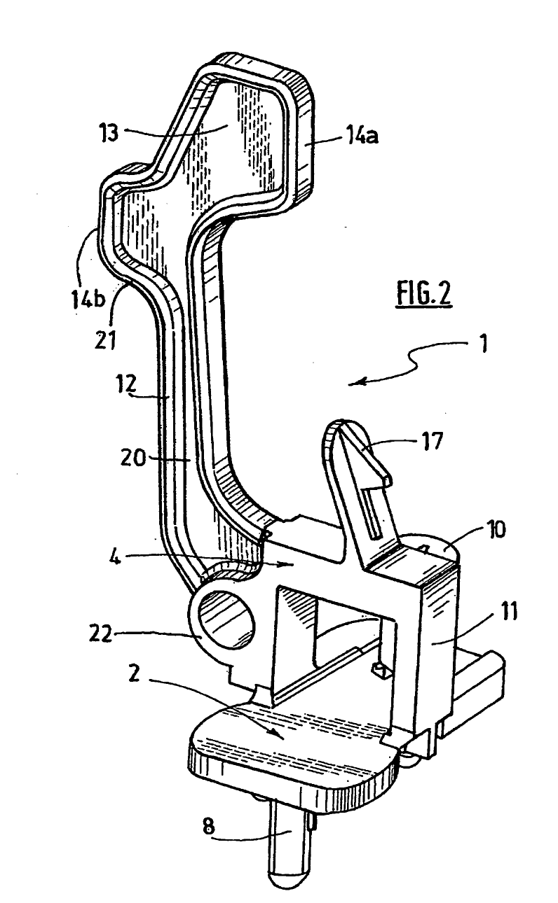

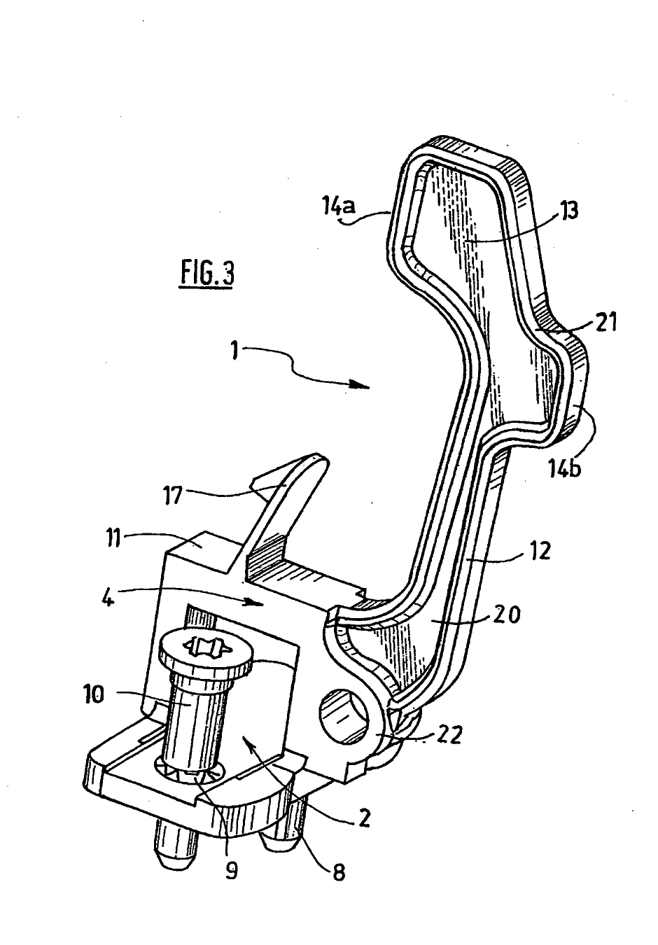

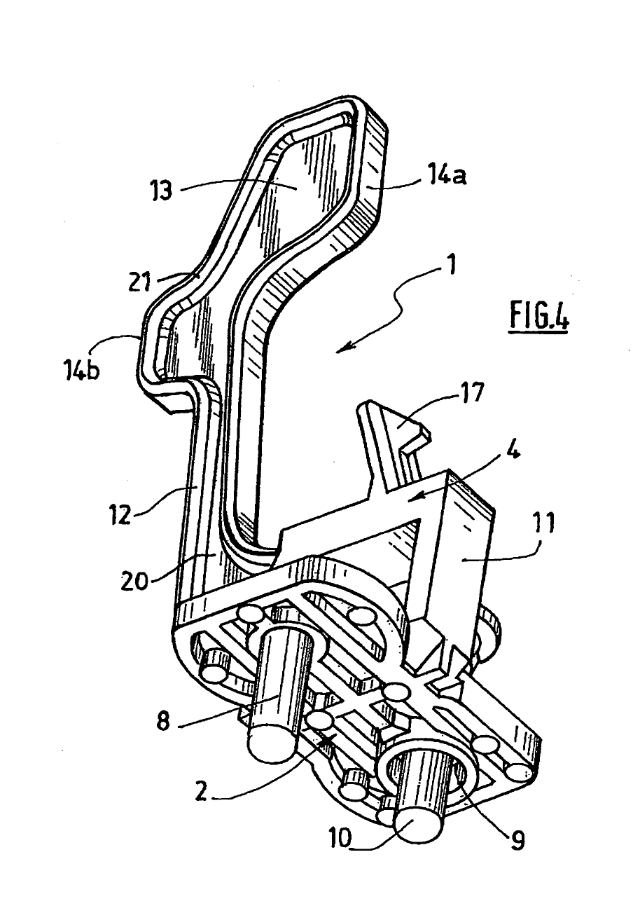

FIGS. 1 to 4 are perspective views from different angles of view of a device for spacing and temporary locking according to the invention.

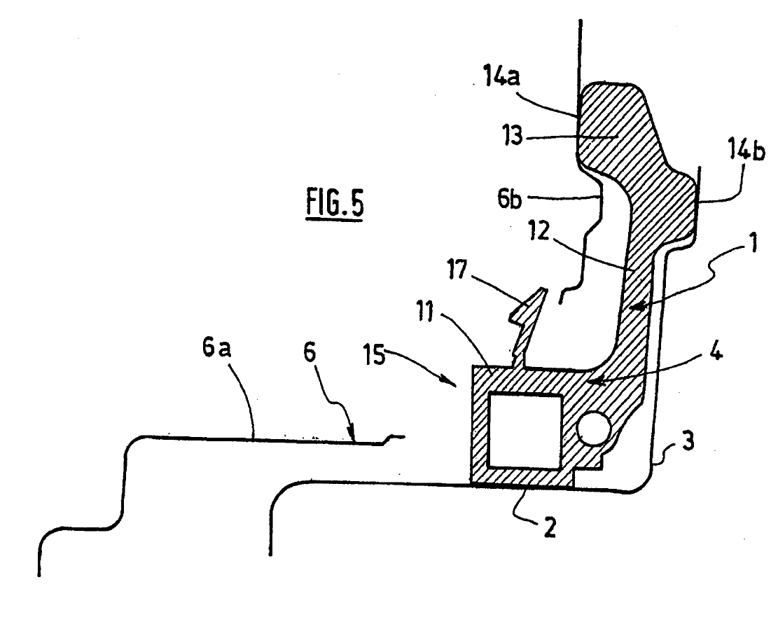

FIG. 5 is a diagrammatic longitudinal cross-section of the device from FIGS. 1 to 4 anchored in a fixed element of the body and maintaining an opening element.

A device 1 for spacing and temporary locking according to the invention, as shown in FIGS. 1 to 5, comprises a single-piece body designed from a shaped thermoplastic material, and being broken down, on one hand, into a fixing plate 2 designed to enable temporary anchoring of the device 1 in a fixed element 3 of a motor vehicle body, and on the other hand, in a stop element 4 designed to serve as a support for an opening element 6.

The fixing plate 2 is equipped with attaching means comprising, on one hand, a peg 8 designed to be inserted into an orifice of the fixed element 3, and on the other hand, a bore 9 designed to receive a fixing screw 10 able to cooperate with a tapped orifice of the fixed element 3. Alternatively, one can provide a fixing system able to be clipped to the means with removable hooks, for example.

The stop element 4 comprises a substantially parallelepiped base 11, hollow in its center, forming a first end through which the stop element is attached to the fixing plate and presents an intermediate part 12 stretching in a direction substantially perpendicular to the fixing plate 2 terminated by a second end 13 curved toward the fixing plate 2. This intermediate part is more generally in the shape of a scorpion's tail.

The intermediate part 12 forms a narrow part connecting the second curved end 13 to the base 11 of the stop element 4. More precisely, the intermediate part 12 is integral with a hollow console 22 arranged on one side of the base 11. The intermediate part 12 and the second curved end 13 are conformed so as to arrange a space able to receive a rim of the opening element 6. The second curved end 13 forms a head presenting, on one hand, a first substantially flat outer surface 14a designed to be oriented in the direction of the opening element 6 to come into contact therewith, and on the other hand, a second substantially flat outer surface 14b designed to be oriented in the direction of the fixed element 3 to come into contact therewith.

The intermediate part 12 is made in the form of a core 20 contained in a plane perpendicular to the fixing plate 2 symmetrically cutting through the stop element 4, and a stiffening rim 21, perpendicular and transverse, extending transversely from one side to the other of the core 20, and continuously along the edge of the core 20.

The intermediate part 12 grants the stop element 4, and more precisely its second curved end 13, a certain flexibility enabling the device 1 to absorb, to a certain extent, any shocks against the opening element 6. The flexibility may be due to the material used and/or the thickness thereof, and/or the shape of the rim 21 relative to the core 20.

Moreover, the device 1 comprises an elastic retaining pin 17 designed to cooperate with the opening element 6 to prevent its opening during the coating state.

A user wishing to maintain an opening element 6 in a closed position relative to a fixed element 3 of a motor vehicle body with the help of a device 1 according to the invention will proceed as follows.

Initially, the fixed element 3 of the body is placed on an assembly chain along which it progresses in order to undergo various assembly operations. This fixed element 3 presents openings designed to receive opening elements 6, such as doors, tailgate, hood. These openings each define, in relation to the fixed element 3 of the body, a plane, for example substantially vertical in the case of a door, which is found in the direction of hinging.

During these assembly operations, the opening elements 6 are mounted on the fixed element 3 with the help of suitable hinges. However, these opening elements 6 are not yet equipped with closing devices and permanent locks. When the body is ready to receive an application of paint or a protective coating, the opening elements 6 must be placed in a position close to their closing position, or pseudo-closed position, so as to coat all of the external parts of the body.

These opening elements 6 are maintained in this position with the help of the device 1 for spacing and temporary locking according to the invention.

To do this, the device 1 for spacing and locking is anchored, with the help of the peg 8 and the fixing screw 10 going through the bore 9 of the fixing plate 2, in the fixed element 3 at the level of a fixing zone (not visible). The fixing plate 2 defines an anchoring plane substantially perpendicular to the plane defined by the opening in the fixed element 3 corresponding to the opening element 6 one wishes to support.

More precisely, in the pseudo-closed position, the device 1 for spacing and locking is provided to be temporarily fixed on the fixed element 3, in the volume which will be occupied by the lock of the opening element 6, corresponding to a housing 15 provided on the latter for said lock. The housing 15 is formed by a cutout formed on an internal surface of the opening element 6 and comprises a rim 6a extending perpendicularly to the plane of the opening element 6 and a rim 6b extending parallel to the plane of the opening element 6.

The fixing plate 2 thus put into place, the second curved end 13 of the stop element 4 bears against the fixed element 3 via the second flat surface 14b of the head.

The opening element 6 is then brought into its pseudo-closed position such that it bears on the first flat surface 14a of the curved end of the intermediate part 12 and locks via the rim 6b while exceeding, then escaping the elastic retaining pin 17. In so doing, the opening element 6 bears on the second end 13 of the stop element 4 which ensures its support and maintenance in the desired pseudo-closed position. The opening element 6 is kept in this position by the retaining pin 17 cooperating with the rim 6b.

During transport of the body through the zone for application of the coat or paint, upon placement of the opening element 6, and during any other manipulations, the opening element 6 is likely to undergo external stresses which cause it to collide with the device(s) 1 ensuring its maintenance. In order to avoid such shocks damaging the body, the curved end 13 of the intermediate part 12 may be made so as to have a certain elasticity enabling it to absorb these potential shocks and thus to prevent them from causing a deformation of the opening element 6, or even a break of the stop 4.

Once the coating or paint has been applied, the devices 1 for spacing and locking are removed and the permanent closing devices as well as the locks can be installed.

Although the invention has been described in connection with specific embodiments, it is obvious that it is in no way limited and that it comprises all of the technical equivalents of the means described as well as their combinations if these fall within the framework of the invention.

1. Device for spacing and temporarily locking into a pseudo-closed position an opening element on a fixed element of a motor vehicle body, comprising a fixing plate for anchoring the device in the fixed element and a stop element adapted to serve as support for the opening element and having one first end attached to the fixing plate, characterized in that the stop element has an intermediate part stretching in a direction substantially perpendicular to the fixing plate and terminated by a second end curved towards the fixing plate, the intermediate part and the second end being configured so as to be accommodated between the fixed element and the opening element in the pseudo-closed position and to provide a space for receiving a rim thereof.

2. Device according to claim 1, wherein the curved end of the stop element is configured so as to come into contact with an area of the opening element designed to receive a covering element.

3. Device according to claim 1, wherein the curved end is adapted so as to be able to come partially into contact with the corresponding fixed element.

4. Device according to claim 1, wherein the curved end is adapted to as to be at least partially elastically deformable under the action of the stresses exerted by the opening element.

5. Device according to claim 1, wherein it comprises an elastic retaining pin able to cooperate with an edge of the opening element to lock said element in the pseudo-closed position.

6. Device according to claim 1, wherein the fixing plate is equipped with a peg designed to cooperate with an opening of the fixed element, and is able to receive a fixing screw designed to cooperate with a tapped orifice of the fixed element.

7. Device according to claim 1, wherein the fixing plate comprises fixing means able to be clipped on the fixed element of the body.

8. Device according to claim 1, wherein it is made from a thermoplastic material able to bear a temperature equal to at least 180° C.

9. Device according to claim 1, wherein stop element is a single piece with the fixing plate.
